(19) United States
(12) Patent Application Publication
(10) Pub. No.: US 2025/0367980 A1
(43) Pub. Date: Dec. 4, 2025

(54) TIRE CAPABLE OF REDUCING PITCH NOISE AND METHOD FOR DESIGNING TIRE TREAD PATTERN THEREOF

(71) Applicant: CHENG SHIN RUBBER IND. CO., LTD., CHANGHUA COUNTY (TW)

(72) Inventor: CHING-MING CHENG, CHANGHUA COUNTY (TW)

(21) Appl. No.: 19/208,803

(22) Filed: May 15, 2025

(30) Foreign Application Priority Data
Jun. 3, 2024 (TW) 113120518

(51) Int. Cl. B60C 11/03

(52) U.S. Cl. CPC B60C 11/0318; B60C 11/0327

(57) ABSTRACT

A tire capable of reducing pitch noise and a method for designing a tire tread pattern thereof are disclosed. The method includes the following steps: generating a plurality of discrete points on a circumferential surface of a tire using a pseudo-random point generator; connecting each of the discrete points and the neighboring discrete points to form triangles according to the Voronoi geometry principle, extending perpendicular bisectors of sides of each of the triangles so that the perpendicular bisectors are intersected to form a Voronoi diagram; reducing the Voronoi diagram by a reduction ratio with each of the discrete points as a center to form a plurality of tread blocks not having concave corners on the circumferential surface of the tire, dividing the circumferential surface of the tire into convex portions and concave portions by means of the tread blocks to form a tire tread pattern of the tire.

### FIELD OF THE INVENTION

The present invention relates to a tire capable of reducing pitch noise and a method for designing a tire tread pattern thereof, and more particularly to a tire having tread blocks not having concave corners on the circumferential surface of the tire according to the Voronoi geometry principle. The tread blocks form a tire tread pattern.

### BACKGROUND OF THE INVENTION

When the vehicle is running, the noise is generated when the tires roll and come into contact with the ground. Tire noise includes aerodynamic noise, air pump noise, cavity resonance, air cylindrical tube resonance, viscous/slip noise, impact and vibration between tread blocks and the road surface, etc. The noise caused by the impact between the tread blocks and the road surface is also known as pitch noise.

Pitch noise is generated due to the geometric shape of the tire tread pattern on the tire surface. The tire tread patterns and pitches are designed to provide good grip, drainage and quietness. Therefore, the tread blocks and pitch of the tire surface are usually designed in irregular shapes and specific arrangements, which is beneficial to increase the friction between the tire and the road surface, thereby increasing traction, helping in draining water on slippery roads and improving driving safety. However, these irregular surface features combined with the pitch arrangement will produce pitch noise when contacting and impacting the road surface.

For example, as disclosed in U.S. Pat. No. 2,014,255A, titled “TREAD FOR PNEUMATIC TIRES”, the tire tread pattern is formed by arranging irregularly-shaped tread blocks into a single pitch, which is then repeated over the entire circumference of the tire. As shown in FIG. 20, the geometric shape of the tread block A of the tire is limited to the shape having three or more sides and includes convex corners A1 and a concave corner A2. However, the design of the tread block A having the concave corner A2 will cause stress concentration at the concave corner A2, resulting in abnormal noise.

### SUMMARY OF THE INVENTION

The primary object of the present invention is to provide a tire capable of reducing pitch noise and a method for designing a tire tread pattern thereof, without affecting the safety performance of tires such as grip and drainage.

According to one aspect of the present invention, a method for designing a tire tread pattern of a tire capable of reducing pitch noise, comprises the following steps: generating a plurality of discrete points on a circumferential surface of a tire using a pseudo-random point generator; connecting each of the discrete points and the neighboring discrete points to form triangles according to the Voronoi geometry principle, extending perpendicular bisectors of sides of each of the triangles so that the perpendicular bisectors are intersected to form a Voronoi diagram; reducing the Voronoi diagram by a reduction ratio with each of the discrete points as a center to form a plurality of tread blocks not having concave corners on the circumferential surface of the tire, dividing the circumferential surface of the tire into raised portions and recessed portions by means of the tread blocks to form a tire tread pattern of the tire.

Furthermore, the number of the discrete points is between 240 and 1000.

Furthermore, the reduction ratio is between 0.99 and 0.7.

Furthermore, the discrete points are evenly distributed over all or part of the circumferential surface of the tire.

Furthermore, the circumferential surface of the tire includes a tread portion and two shoulder portions adjacent to the tread portion, and the discrete points are evenly distributed on the tread portion.

Furthermore, the circumferential surface of the tire includes a tread portion and two shoulder portions adjacent to the tread portion, and the discrete points are evenly distributed on one of the shoulder portions.

Furthermore, the circumferential surface of the tire includes an inner side portion and an outer side portion that are arranged sequentially in an axial direction of the tire. The inner side portion and the outer side portion each occupy half of a width of the circumferential surface of the tire in the axial direction. The ratio of the number of the discrete points of the inner side portion to the number of the discrete points of the outer side portion is between 0:10 and 5:5. Furthermore, the ratio of the number of the discrete points of the inner side portion to the number of the discrete points of the outer side portion is 6:4.

Furthermore, the circumferential surface of the tire includes an inner side portion, a central portion and an outer side portion that are arranged sequentially in an axial direction of the tire. The inner side portion and the outer side portion each occupy a quarter of a width of the circumferential surface of the tire in the axial direction. The central portion occupies half of the width of the circumferential surface of the tire in the axial direction. The number of the discrete points of the inner side portion, the number of the discrete points of the central portion and the number of the discrete points of the outer side portion are in the ratio of 2:6:2.

According to another aspect of the present invention, a tire capable of reducing pitch noise manufactured using the foregoing method is provided.

The following effects can be achieved according to the above technical features:

1. The present invention adopts the Voronoi geometry principle to form a tire tread pattern on the circumferential surface of the tire, and the tread blocks of the tire tread pattern have no concave corners. As shown in the tread pattern spectrograms of the tire, the tread blocks having concave corners of the conventional tire have the problem that there is pitch noise concentrated at specific frequencies and locations. The tire provided by the present invention does not have the phenomenon that the pitch noise is concentrated at specific frequencies and locations, thereby achieving better noise energy dispersion.

2. The more the number of the tread blocks is, the better the spectral dispersion of the pitch noise is. In the present invention, the number of the Voronoi tread blocks is designed to be between 240 and 1000, so as to take into account the performance of the tire in terms of grip and drainage.

3. The Voronoi diagram is reduced by a reduction ratio to form the tread blocks. The larger the reduction ratio, the better the spectral dispersion of the pitch noise. In the present invention, the reduction ratio of the Voronoi diagram is between 0.99 and 0.7, so as to take into account the performance of the tire in terms of grip and drainage.

4. The distribution mode of tread blocks can be changed based on different types of tires, such as car tires, truck tires, and bicycle tires. For example, the inner side portion and the outer side portion of the tire have different numbers of tread blocks; or the inner side portion, the middle portion and the outer side portion of the tire have different numbers of tread blocks; or only the tread portion or one of the shoulder portions of the tire has the tread blocks. All of which can have the effect of improving the spectral dispersion of the pitch noise.

### BRIEF DESCRIPTION OF THE DRAWINGS

FIG. 1 is a schematic diagram of an embodiment of the present invention, illustrating that a pseudo-random point generator in computer graphics software is used to distribute multiple discrete points over the circumferential surface of a tire;

FIG. 2 is a schematic diagram of the embodiment of the present invention, illustrating that the discrete points on the circumferential surface of the tire are connected to form triangles;

FIG. 3 is a schematic diagram of the embodiment of the present invention, illustrating that the perpendicular bisectors of the sides of each of the triangles are connected to form a Voronoi polygon;

FIG. 4 is a schematic diagram of the embodiment of the present invention, illustrating that the Voronoi diagram on the circumferential surface of the tire is reduced by a reduction ratio to form a tire tread pattern;

FIG. 5 is a perspective view of a tire having a first type of tire tread pattern according to the embodiment of the present invention, in which the tread blocks are evenly distributed on the entire circumferential surface of the tire;

FIG. 6 is a front view of FIG. 5;

FIG. 7A illustrates a tread pattern of the tire according to the embodiment of the present invention;

FIG. 7B illustrates a tread pattern spectrogram of the tire according to the embodiment of the present invention;

FIG. 8A illustrates a first variation of the tread pattern of the tire according to the embodiment of the present invention;

FIG. 8B illustrates a tread pattern spectrogram of the tire having the first variation of the tread pattern;

FIG. 9A illustrates a second variation of the tread pattern of the tire according to the embodiment of the present invention;

FIG. 9B illustrates a tread pattern spectrogram of the tire having the second variation of the tread pattern;

FIG. 10A illustrates a tread pattern of a conventional tire having tread blocks with concave corners;

FIG. 10B illustrates a tread pattern spectrogram of the conventional tire having the tread blocks with concave corners;

FIG. 11 is a perspective view of a tire having a second type of tire tread pattern according to the embodiment of the present invention, in which the tread blocks are evenly distributed on the tread portion of the tire;

FIG. 12 is a front view of FIG. 11;

FIG. 13 is a perspective view of a tire having a third type of tire tread pattern according to the embodiment of the present invention, in which the tread blocks are evenly distributed on one of the shoulder portions of the tire;

FIG. 14 is a front view of FIG. 13;

FIG. 15 is a schematic diagram of a tire having a fourth type of tire tread pattern, wherein the inner side portion and the outer side portion of the circumferential surface of the tire are designed with different numbers of discrete points, and different numbers of tread blocks are formed on the inner side portion and the outer side portion;

FIG. 16 is a schematic diagram of a tire having a fifth type of tire tread pattern, wherein the inner side portion, the middle portion and the outer side portion of the circumferential surface of the tire are designed with different numbers of discrete points, and different numbers of tread blocks are formed on the inner side portion, the middle portion and the outer side portion;

FIG. 17 is a histogram comparing the spectral dispersion of the pitch noise of the tires having different numbers of tread blocks according to the embodiment of the present invention;

FIG. 18 is a histogram comparing the spectral dispersion of the pitch noise of the tread blocks in different distribution modes according to the embodiment of the present invention;

FIG. 19 is a histogram comparing the spectral dispersion of the pitch noise of the tread blocks at different reduction ratios according to the embodiment of the present invention; and

FIG. 20 is a schematic view of a tread block with a concave corner of a conventional tire.

### DETAILED DESCRIPTION OF THE PREFERRED EMBODIMENTS

Embodiments of the present invention will now be described, by way of example only, with reference to the accompanying drawings.

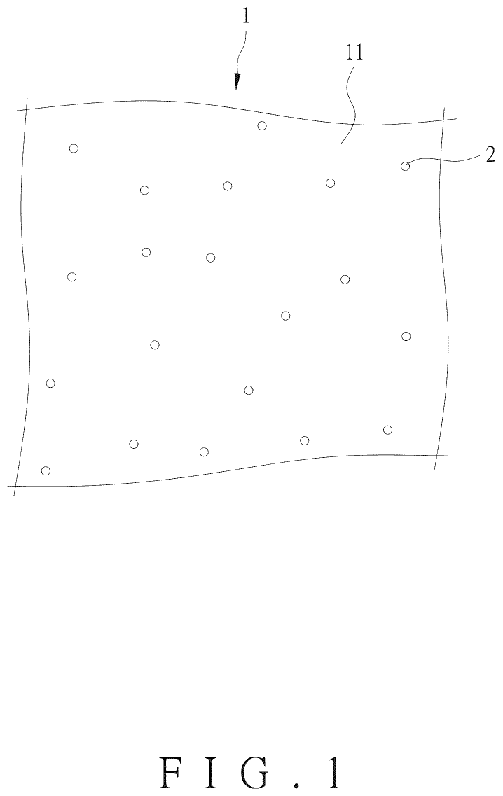

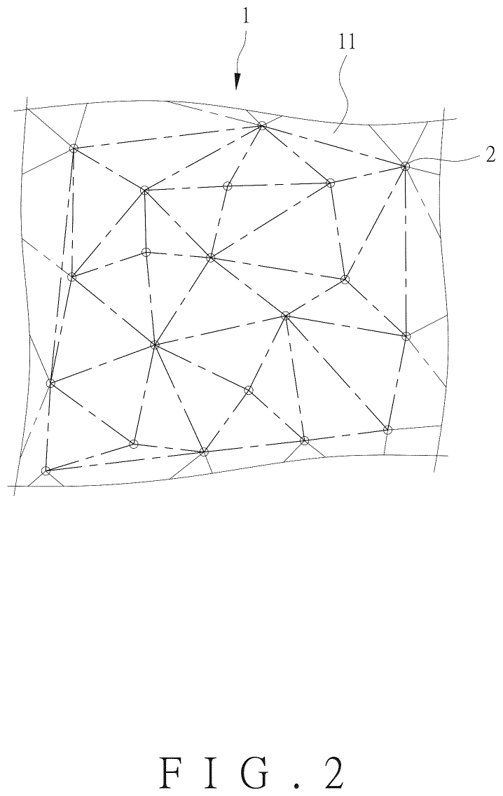

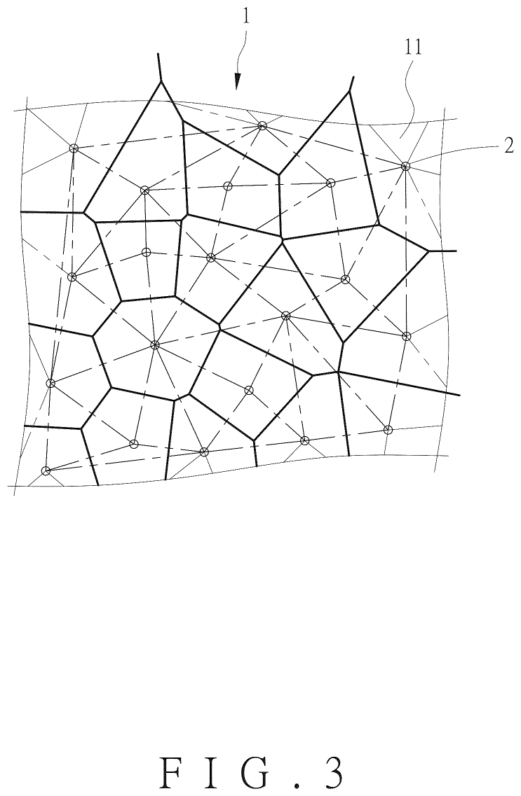

The present invention discloses a tire capable of reducing pitch noise and a method for designing a tire tread pattern thereof. As shown in FIG. 1 through FIG. 4, the method comprises the following steps:

A plurality of discrete points 2 are generated on the circumferential surface 11 of a tire 1 using a pseudo-random point generator. The number of the discrete points 2 is between 240 and 1000. According to the Voronoi geometry principle, each of the discrete points 2 and the neighboring discrete points 2 are connected to form triangles, that is, Delaunay triangulation. The perpendicular bisectors of the sides of each of the triangles are extended and intersected to form a Voronoi diagram. The Voronoi diagram is reduced by a reduction ratio with each discrete point as the center. The reduction ratio is between 0.99 and 0.7. The circumferential surface 11 of the tire 1 is formed with a plurality of tread blocks 12 not having concave corners. The tread blocks 12 divide the circumferential surface 11 of the tire 1 into raised portions and recessed portions, thereby forming a tire tread pattern of the tire 1.

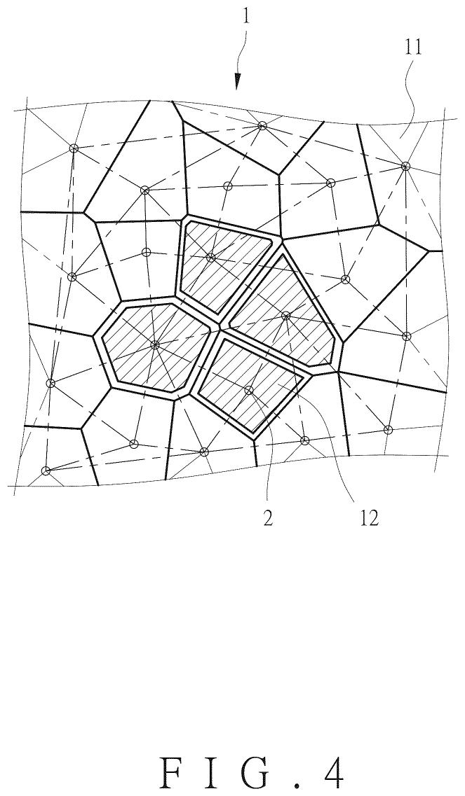

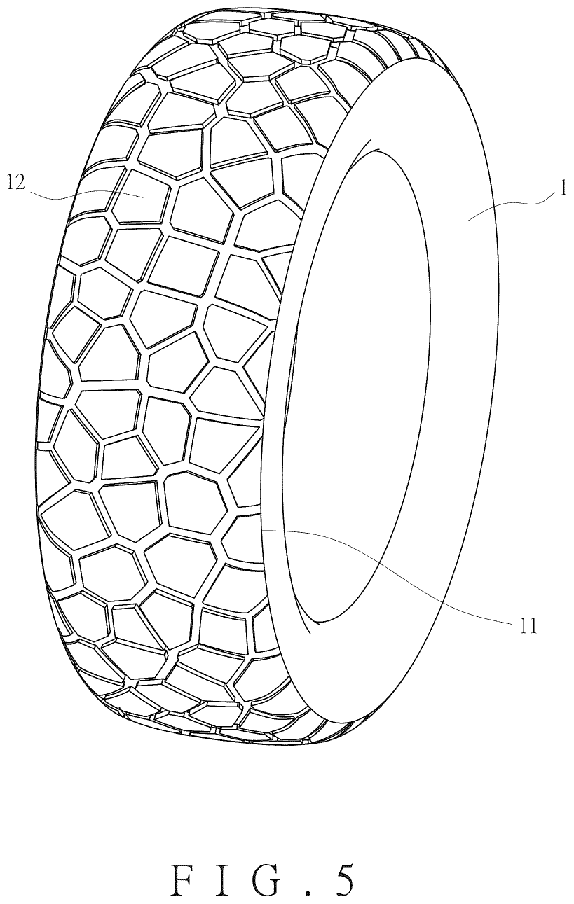

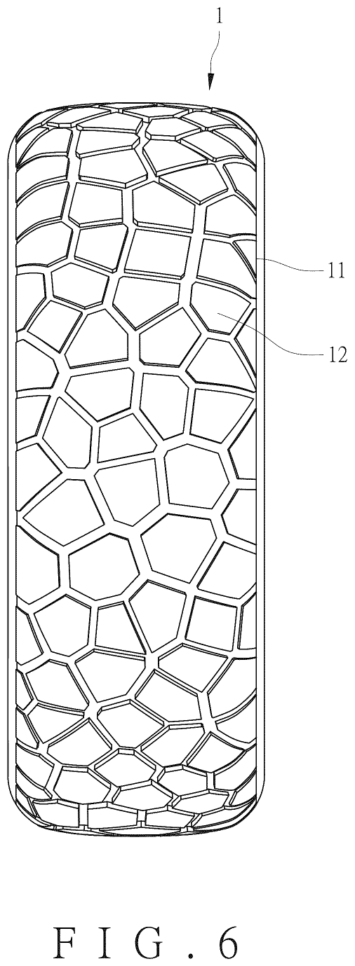

FIG. 5 and FIG. 6 illustrate the tire 1 having a first type of tire tread pattern according to the embodiment of the present invention. The discrete points 2 (as shown in FIG. 4) are evenly distributed on the entire circumferential surface 11 of the tire 1. The tread blocks 12 are formed on the entire circumferential surface 11 of the tire 1.

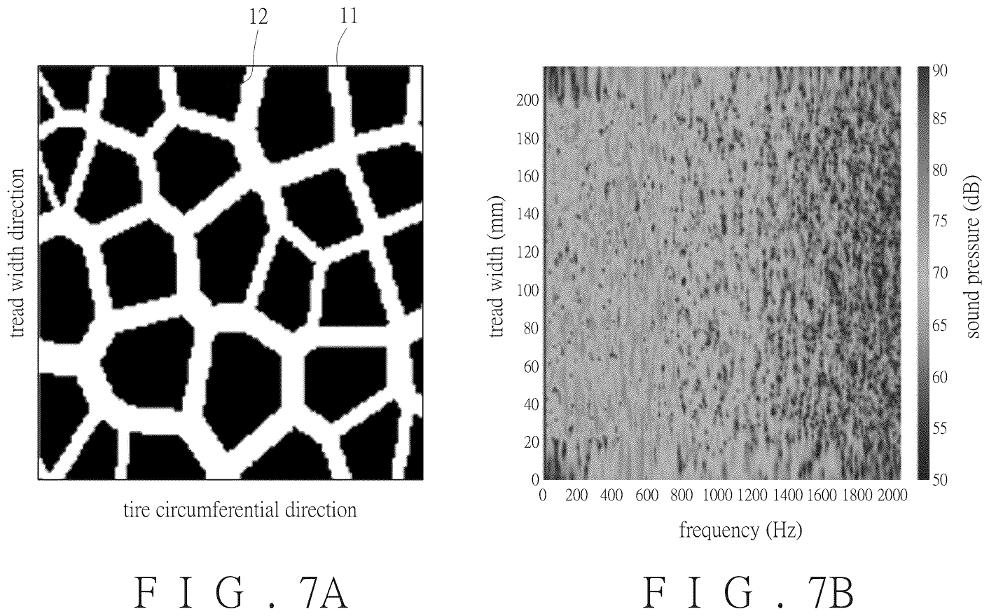

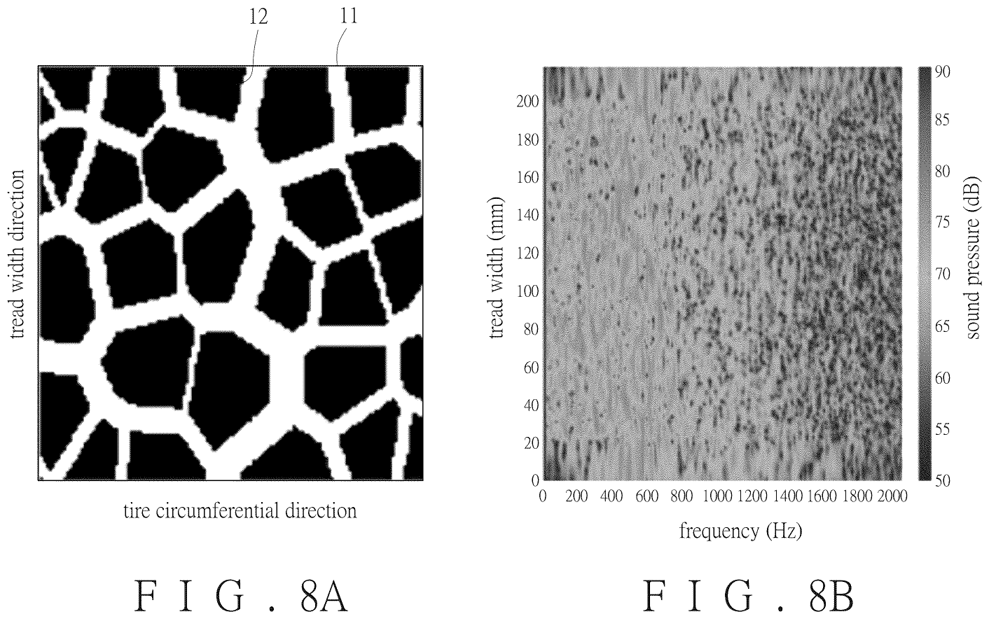

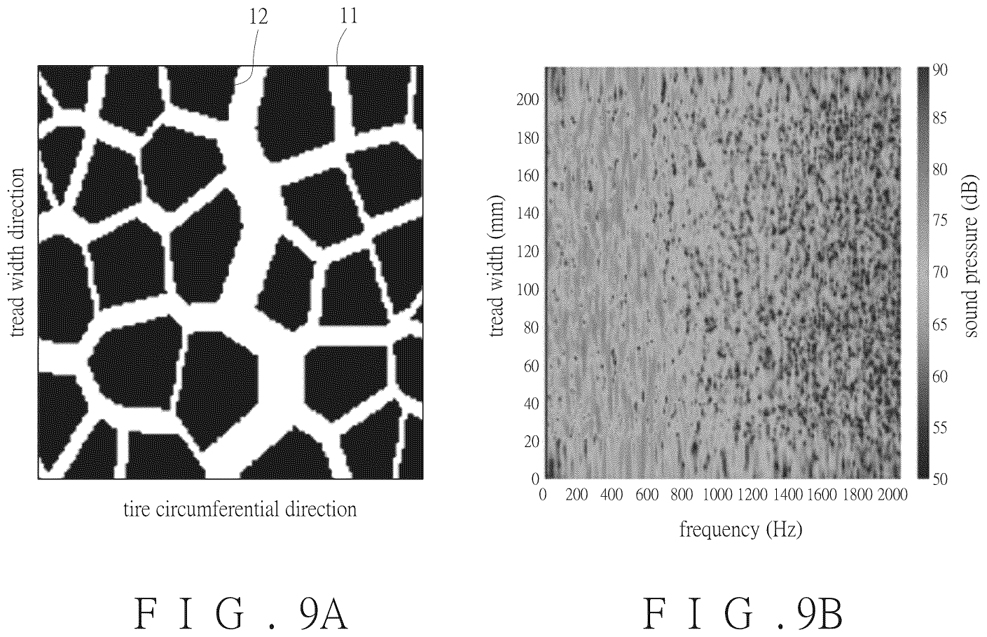

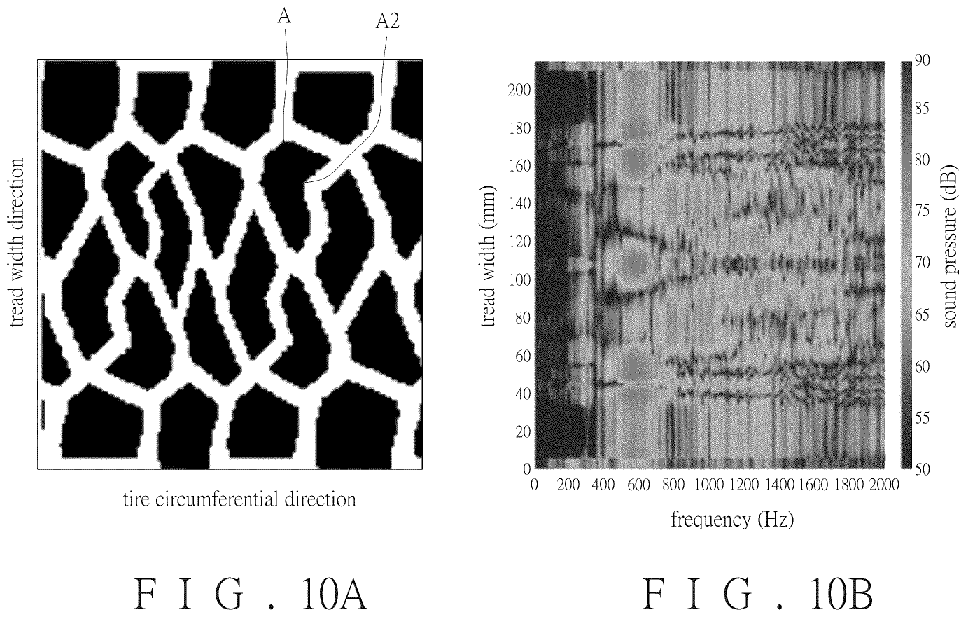

FIG. 7A illustrates the first type of tire tread pattern. FIG. 7B illustrates a tread pattern spectrogram of the tire 1 having the first type of tire tread pattern. The tread pattern spectrogram is obtained through noise spectrum simulation and shows that there is no pitch noise concentrated at specific frequencies and locations. FIGS. 8A and 9A respectively illustrate different variations of the first type of tire tread pattern. FIGS. 8B and 9B respectively illustrate tread pattern spectrograms, obtained through noise spectrum simulation, of the tire 1 having different variations of the first type of tire tread pattern. The spacing between some of the tread blocks 12 is slightly adjusted to increase or decrease the width of the grooves, depending on the grip or drainage needs of the tire 1. Similarly, the tread pattern spectrograms show that there is no pitch noise concentrated at specific frequencies and locations. FIG. 10A illustrates a tread pattern of the conventional tire having the tread blocks A with the concave corners A2. FIG. 10B illustrates a tread pattern spectrogram, obtained through noise spectrum simulation, of the conventional tire having the tread blocks A with the concave corners A2. The tread pattern spectrograms show that there is pitch noise concentrated at specific frequencies and locations.

Referring to Table 1 below, the spectral dispersion of the pitch noise is calculated for the conventional tire having tread blocks with concave corners and for the tire 1 having the first type of tire tread pattern and the tire 1 having the first type of tire tread pattern with variations.

TABLE 1

| | conventional | tire having | tire having a | tire having a |
|---|---|---|---|---|
| | tire | the first | first variation | second |
| | having tread | type | of the | variation |
| | blocks with | of tire | first type of | of the first |
| | concave | tread | tire tread | type of tire |
| | corners | pattern | pattern | tread pattern |
| | 0.00041 | 0.00029 | 0.00030 | 0.00034 |
| spectral | 100% | 138% | 137% | 120% |
| dispersion from | | | | |
| 0 Hz to 1500 Hz | | | | |

According to the tread pattern spectrograms in FIGS. 7B, 8B, 9B, and 10B and the spectral dispersion of the pitch noise in Table 1, the tire 1 provided by the present invention does not have the phenomenon that the pitch noise is concentrated at specific frequencies and locations. The tire 1 is able to achieve better noise energy dispersion.

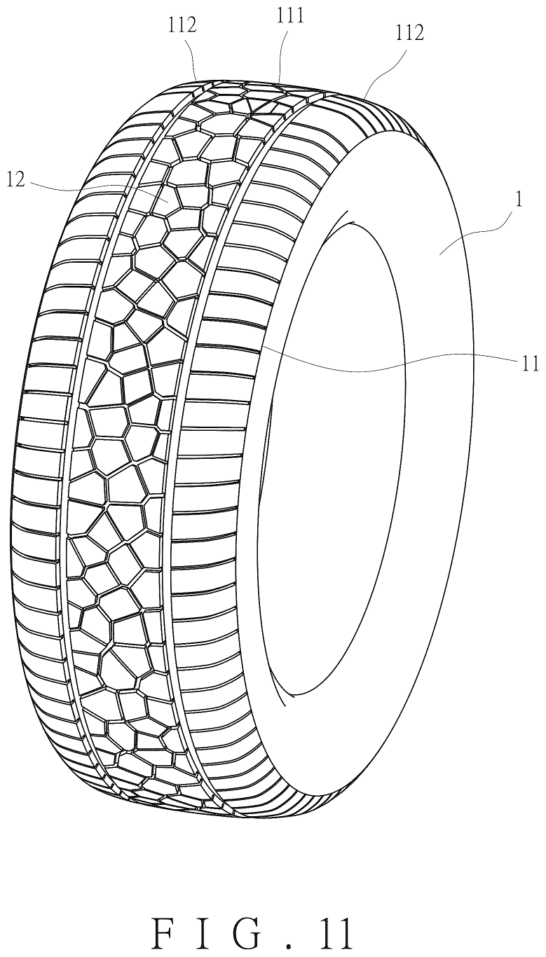

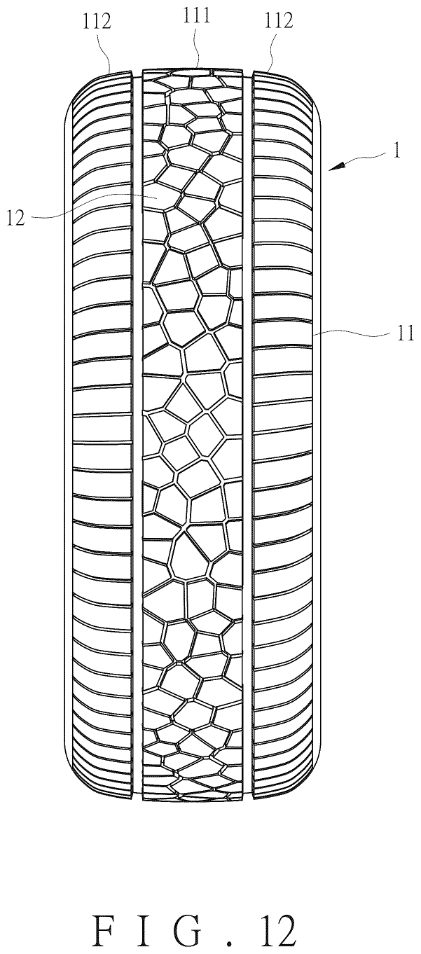

FIG. 11 and FIG. 12 illustrate a second type of tire tread pattern. The circumferential surface 11 of the tire 1 includes a tread portion 111 and two shoulder portions 112 adjacent to the tread portion 111. According to the performance requirements of the tire, the discrete points 2 (as shown in FIG. 4) are evenly distributed on the tread portion 111. The tread blocks 12 are evenly formed on the tread portion 111.

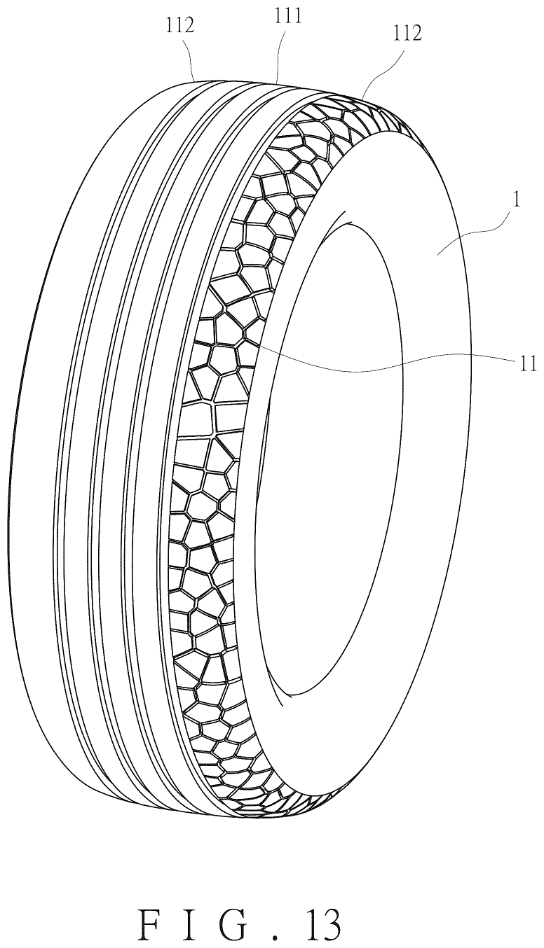

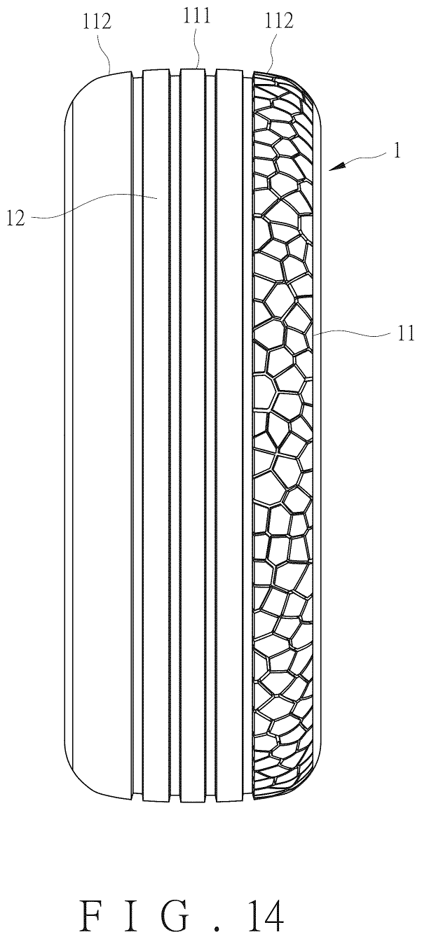

FIG. 13 and FIG. 14 illustrate a third type of tire tread pattern. According to the performance requirements of the tire, the discrete points 2 (as shown in FIG. 4) are evenly distributed on one of the shoulder portions 112. The tread blocks 12 are evenly formed on the shoulder portion 112.

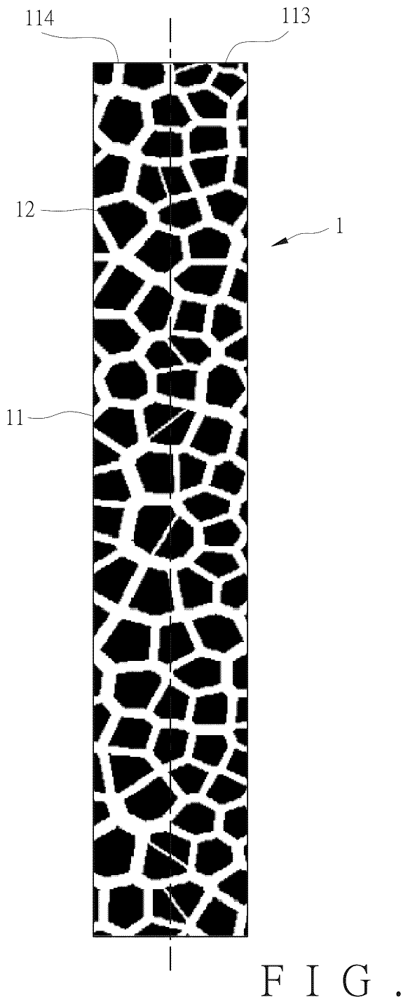

FIG. 15 illustrates a fourth type of tire tread pattern. The circumferential surface 11 of the tire 1 includes an inner side portion 113 and an outer side portion 114 that are arranged sequentially in the axial direction of the tire 1. The inner side portion 113 and the outer side portion 114 each occupy half of the width of the circumferential surface 11 of the tire 1 in the axial direction. Depending on the performance requirements of the tire, the ratio of the number of the discrete points 2 (as shown in FIG. 4) of the inner side portion 113 to the number of the discrete points 2 of the outer side portion 114 is between 0:10 and 5:5. For example, the ratio of the number of the discrete points 2 of the inner side portion 113 to the number of the discrete points 2 of the outer side portion 114 is 6:4. Similarly, the discrete points 2 are evenly distributed on the inner side portion 113 and the outer side portion 114 for forming the evenly-distributed tread blocks 12.

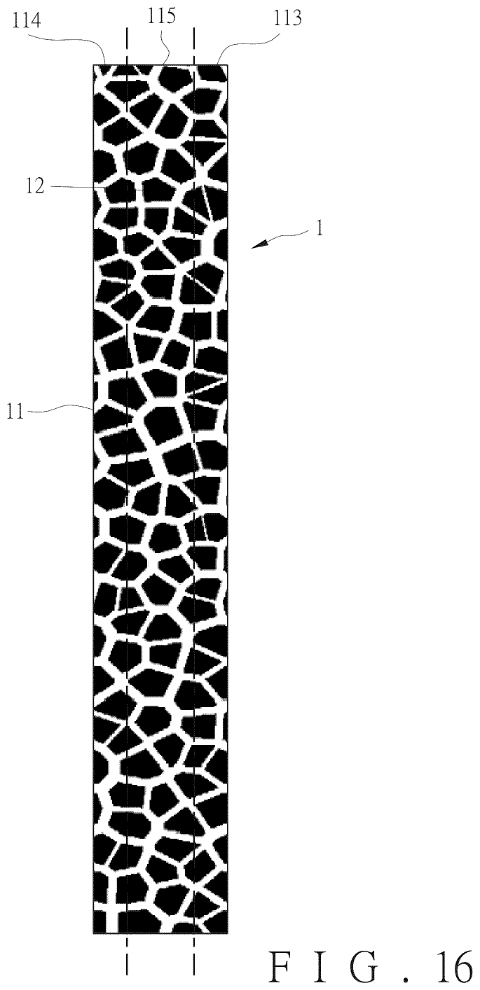

FIG. 16 illustrates a fifth type of tire tread pattern. The circumferential surface 11 of the tire 1 includes an inner side portion 113, a central portion 115 and an outer side portion 114 that are arranged sequentially in the axial direction of the tire 1. The inner side portion 113 and the outer side portion 114 each occupy a quarter of the width of the circumferential surface 11 of the tire 1 in the axial direction. The central portion 115 occupies half of the width of the circumferential surface 11 of the tire 1 in the axial direction. Depending on the performance requirements of the tire, the number of the discrete points 2 of the inner side portion 113, the number of the discrete points 2 of the central portion 115 and the number of the discrete points 2 of the outer side portion 114 are in the ratio of 2:6:2.

The tire 1 with various types of tire tread pattern illustrates that the present invention utilizes the Voronoi geometric principle to form the tread blocks 12 not having concave corners, and the tread blocks 12 can be arranged in different distribution modes according to performance requirements of the tire, but not limited to the foregoing types.

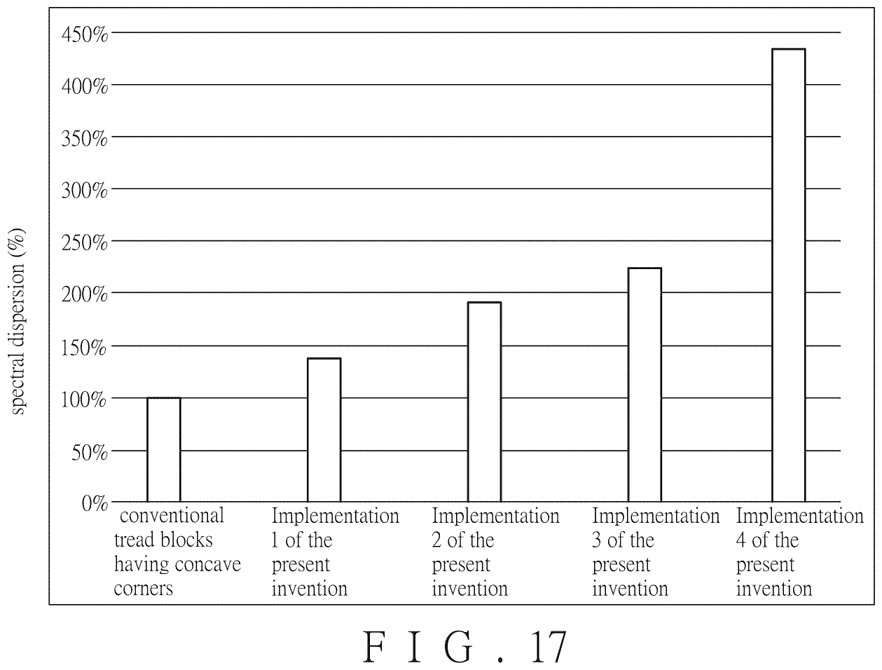

Referring to FIG. 17 and Table 2 below, the noise spectrum simulation of the tire 1 having the tread blocks 12 evenly distributed on the entire circumferential surface 11 and having different numbers of the tread blocks 12 is shown. Compared with the tread blocks having concave corners of the conventional tire, when the number of the tire tread blocks 12 of the present invention is between 240 and 1000, the spectral dispersion is better. The more the number of the tread blocks 12 is, the better the spectral dispersion is. The user can select a tire having a desired number of the tread blocks 12 according to the performance requirements of the tire.

TABLE 2

| | conventional | | | | |
|---|---|---|---|---|---|
| | tread blocks | Implementation | Implementation | Implementation | Implementation |
| | having concave | 1 of the present | 2 of the present | 3 of the present | 4 of the present |
| | corners | invention | invention | invention | invention |
| the | 240 | 240 | 400 | 500 | 1000 |
| number | | | | | |
| of tread | | | | | |
| blocks | | | | | |
| | evenly | evenly | evenly | evenly | evenly |
| | distributed on | distributed on | distributed on | distributed on | distributed on |
| distribution | the entire | the entire | the entire | the entire | the entire |
| mode | circumference | circumference | circumference | circumference | circumference |
| reduction | | 0.778 | 0.7805 | 0.7815 | 0.7843 |
| ratio | | | | | |
| void ratio | 37.70% | 37.71% | 37.75% | 37.71% | 37.72% |
| spectral | 0.000408 | 0.000295 | 0.000212 | 0.000182 | 0.000094 |
| dispersion | 100% | 138% | 192% | 225% | 436% |

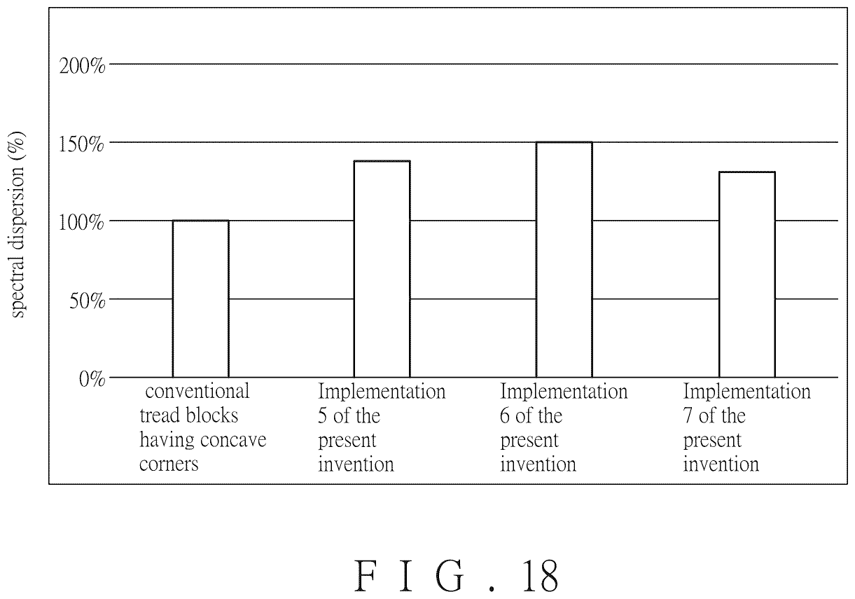

Referring to FIG. 18 and Table 3 below, the noise spectrum simulation of the tire 1 having the first type, the fourth type and the fifth type of tire tread pattern is shown. Compared with the tread blocks having concave corners of the conventional tire, the spectral dispersion is better. The user can select a tire having a desired type of tire tread pattern according to the performance requirements of the tire.

TABLE 3

| | conventional | | | |
|---|---|---|---|---|
| | tread | Imple- | Imple- | Imple- |
| | blocks | mentation | mentation | mentation |
| | having | 5 of the | 6 of the | 7 of the |
| | concave | present | present | present |
| | corners | invention | invention | invention |
| the number | 240 | 240 | 96/144 | 48/144/48 |
| of tread | | | | |
| blocks | | | | |
| | | | | the outer side |
| | | | | portion/the |
| | evenly | evenly | the outer side | central |
| | distributed on | distributed on | portion/the | portion/the |
| distribution | the entire | the entire | inner side | inner side |
| mode | circumference | circumference | portion | portion |
| reduction | | 0.778 | 0.7782 | 0.7765 |
| ratio | | | | |
| void ratio | 37.70% | 37.71% | 37.71% | 37.71% |
| spectral | 0.000408 | 0.000295 | 0.000272 | 0.000311 |
| dispersion | 100% | 138% | 150% | 131% |

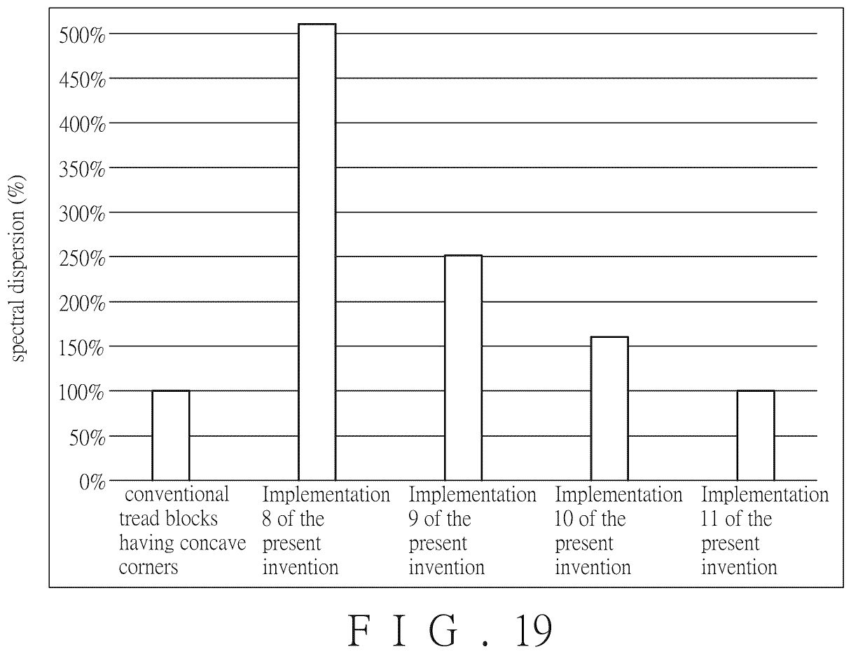

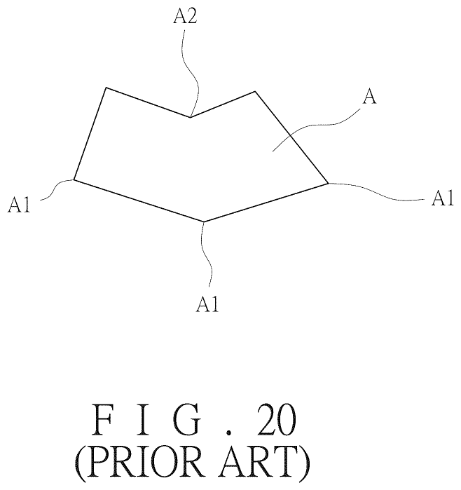

Referring to FIG. 19 and Table 4 below, the noise spectrum simulation of the tread blocks 12 obtained by reducing the Voronoi diagram at different reduction ratios is shown. Compared with the tread blocks having concave corners of the conventional tire, when the reduction ratio is between 0.9 and 0.7, the spectral dispersion is better. The larger the reduction ratio, the better the spectral dispersion of the obtained tread blocks 12.

TABLE 4

| | conventional | | | | |
|---|---|---|---|---|---|
| | tread blocks | | | | Implementation |
| | having | Implementation 8 | Implementation 9 | Implementation | 11 of the |
| | concave | of the present | of the present | 10 of the present | present |
| | corners | invention | invention | invention | invention |
| the | 240 | 240 | 240 | 240 | 240 |
| number | | | | | |
| of tread | | | | | |
| blocks | | | | | |
| | evenly | evenly | evenly | evenly | evenly |
| | distributed on | distributed on the | distributed on the | distributed on the | distributed on |
| distribution | the entire | entire | entire | entire | the entire |
| mode | circumference | circumference | circumference | circumference | circumference |
| reduction | | 0.9 | 0.85 | 0.8 | 0.7 |
| ratio | | | | | |
| void ratio | 37.70% | 18.04% | 26.42% | 34.35% | 48.9% |
| spectral | 0.000408 | 0.000080 | 0.000162 | 0.000255 | 0.000409 |
| dispersion | 100% | 509% | 251% | 160% | 100% |

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method for designing a tire tread pattern of a tire capable of reducing pitch noise, comprising the following steps:
generating a plurality of discrete points on a circumferential surface of a tire using a pseudo-random point generator;
connecting each of the discrete points and the neighboring discrete points to form triangles according to the Voronoi geometry principle, extending perpendicular bisectors of sides of each of the triangles so that the perpendicular bisectors are intersected to form a Voronoi diagram;
reducing the Voronoi diagram by a reduction ratio with each of the discrete points as a center to form a plurality of tread blocks not having concave corners on the circumferential surface of the tire, dividing the circumferential surface of the tire into raised portions and recessed portions by means of the tread blocks to form a tire tread pattern of the tire.

2. The method as claimed in claim 1, wherein the number of the discrete points is between 240 and 1000.

3. The method as claimed in claim 1, wherein the reduction ratio is between 0.99 and 0.7.

4. The method as claimed in claim 1, wherein the discrete points are evenly distributed over all or part of the circumferential surface of the tire.

5. The method as claimed in claim 4, wherein the circumferential surface of the tire includes a tread portion and two shoulder portions adjacent to the tread portion, and the discrete points are evenly distributed on the tread portion.

6. The method as claimed in claim 4, wherein the circumferential surface of the tire includes a tread portion and two shoulder portions adjacent to the tread portion, and the discrete points are evenly distributed on one of the shoulder portions.

7. The method as claimed in claim 4, wherein the circumferential surface of the tire includes an inner side portion and an outer side portion that are arranged sequentially in an axial direction of the tire, the inner side portion and the outer side portion each occupy half of a width of the circumferential surface of the tire in the axial direction; the ratio of the number of the discrete points of the inner side portion to the number of the discrete points of the outer side portion is between 0:10 and 5:5.

8. The method as claimed in claim 7, wherein the ratio of the number of the discrete points of the inner side portion to the number of the discrete points of the outer side portion is 6:4.

9. The method as claimed in claim 4, wherein the circumferential surface of the tire includes an inner side portion, a central portion and an outer side portion that are arranged sequentially in an axial direction of the tire, the inner side portion and the outer side portion each occupy a quarter of a width of the circumferential surface of the tire in the axial direction, the central portion occupies half of the width of the circumferential surface of the tire in the axial direction; the number of the discrete points of the inner side portion, the number of the discrete points of the central portion and the number of the discrete points of the outer side portion are in the ratio of 2:6:2.

10. A tire capable of reducing pitch noise manufactured using the method as claimed in claim 1.

11. The tire capable of reducing pitch noise as claimed in claim 10, wherein the number of the discrete points is between 240 and 1000.

12. The tire capable of reducing pitch noise as claimed in claim 10, wherein the reduction ratio is between 0.99 and 0.7.

13. The tire capable of reducing pitch noise as claimed in claim 10, wherein the discrete points are evenly distributed over all or part of the circumferential surface of the tire.

14. The tire capable of reducing pitch noise as claimed in claim 13, wherein the circumferential surface of the tire includes a tread portion and two shoulder portions adjacent to the tread portion, and the discrete points are evenly distributed on the tread portion.

15. The tire capable of reducing pitch noise as claimed in claim 13, wherein the circumferential surface of the tire includes a tread portion and two shoulder portions adjacent to the tread portion, and the discrete points are evenly distributed on one of the shoulder portions.

16. The tire capable of reducing pitch noise as claimed in claim 13, wherein the circumferential surface of the tire includes an inner side portion and an outer side portion that are arranged sequentially in an axial direction of the tire, the inner side portion and the outer side portion each occupy half of a width of the circumferential surface of the tire in the axial direction; the ratio of the number of the discrete points of the inner side portion to the number of the discrete points of the outer side portion is between 0:10 and 5:5.

17. The tire capable of reducing pitch noise as claimed in claim 16, wherein the ratio of the number of the discrete points of the inner side portion to the number of the discrete points of the outer side portion is 6:4.

18. The tire capable of reducing pitch noise as claimed in claim 13, wherein the circumferential surface of the tire includes an inner side portion, a central portion and an outer side portion that are arranged sequentially in an axial direction of the tire, the inner side portion and the outer side portion each occupy a quarter of a width of the circumferential surface of the tire in the axial direction, the central portion occupies half of the width of the circumferential surface of the tire in the axial direction; the number of the discrete points of the inner side portion, the number of the discrete points of the central portion and the number of the discrete points of the outer side portion are in the ratio of 2:6:2.
